(19) United States
(12) Patent Application Publication
(10) Pub. No.: US 2007/0139343 A1
(43) Pub. Date: Jun. 21, 2007

(54) Liquid crystal display panel with photo sensors and method for adjusting reference voltage in the panel

(75) Inventors: Shih-Hsin Wang, Miao-Li (TW); Ti-Kai Chao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/641,414

(22) Filed: Dec. 18, 2006

(30) Foreign Application Priority Data
Dec. 16, 2005 (TW) 94144821

(51) Int. Cl. G09G 3/36

(52) U.S. Cl. 345/98

(57) ABSTRACT

An exemplary liquid crystal display (LCD) panel includes scan lines, data lines, a scan driver connected to the scan lines, a data driver connected to the data lines, a controller connected to the scan driver and the data driver, and pixels formed by the scan lines and the data lines. The LCD panel is divided into five detecting regions, and the first detecting region is in a center of the LCD panel, and others surround the center portion of the LCD panel. Each detecting region includes a photo sensor. The controller is used to control the five detecting regions to have substantially the same flicker level.

### BACKGROUND OF THE INVENTION

1. Field of the Invention

The present invention relates to a liquid crystal display (LCD) panel and a method for adjusting voltage applied in the LCD panel; and particularly to an LCD panel with a reduced flicker effect, and a method for adjusting voltage applied in the LCD panel in order to reduce or even eliminate any flicker effect.

2. General Background

Generally, one well-known major disadvantage of cathode ray tube (CRT) monitors is the flicker problem. Liquid crystal display (LCD) monitors can also exhibit the flicker problem. In practice, a user is liable to be inconvenienced or annoyed by the flicker problem no matter which kind of monitor he or she has.

The reason for the occurrence of the flicker problem in an LCD monitor is as follows. To illustrate why an LCD panel flickers, suppose that a manufactured LCD panel has a common voltage (Vcom) of 5.5V according to its specifications. If an input video signal varies between 0 V and 10V, the full-scale voltage applied to different electric fields of the pixel-based graphic display varies accordingly. In one field, the full-scale voltage may be 4.5V; and in another field, the full-scale voltage may be 5.5V. This difference in full-scale voltage translates to a difference in light intensity, which is perceived as flicker by a viewer.

In mass manufacturing, due to the variations in the construction of each LCD panel, the optimal Vcom voltage can differ from LCD panel to LCD panel or even across a single LCD panel. Original equipment manufacturers must therefore adjust each of the LCD panels coming out of the factory to eliminate flicker. For small LCD screens where the backplane of the LCD panel can be considered as a low-impedance ground, a single potentiometer can be connected to the LCD panel for adjustment of the common voltage. Traditionally, the potentiometer is manually connected to the LCD panel, and the adjustment is performed by a human operator. However, this procedure has low precision, and the LCD panel is liable to be accidentally damaged by the operator. In addition, the procedure is generally only suitable for small LCD panels. Furthermore, due to human error in viewing the displayed image, the flicker problem may still occur in the LCD panel even after meticulous adjustment by the operator.

What is needed, therefore, is a liquid crystal display panel and a method for adjusting voltage applied in a liquid crystal display panel which can overcome the above-described problems.

### SUMMARY

An exemplary of liquid crystal display panel (LCD) includes a plurality of scan lines, a plurality of data lines, a scan driver, a data driver, a timing controller, and a common electrode. The scan lines and the data lines cross each other and form a crisscross matrix which defines a plurality of pixels. Both of the data and scan drivers are used to drive the pixels. The controller electrically connects to the scan driver and the data driver. The LCD panel defines a first detecting area and a second detecting area. The first detecting area is located in a center portion of the LCD panel and the second detecting area is located in a portion of LCD panel other than the center portion. Each of the first and second detecting area includes a photo sensor (e.g. a photonic diode or a photonic transistor, etc.). By comparing a flicker level of the first detecting area and a minimum value of the flicker level of the second detecting area through the photo sensors so as to adjust a voltage applied to the common electrode through the timing controller. Therefore, the flicker problem can be substantially eliminated.

An exemplary of method for adjusting voltage applied in an LCD panel is also provided. The LCD panel includes a first detecting area and a second detecting area where the first detecting area is located in a center portion of the LCD panel and the second detecting area is located in a portion other than the center portion of the LCD panel. The method includes the following steps: (a) detecting a brightness of the at least one first detecting area and a brightness of the second detecting area; (b) transforming each of the brightnesses of the at least one first detecting area and the second detecting area to an analog signal; (c) obtaining at least one minimum value of first flicker level from the at least one first detecting area and a second flicker level from the second detecting area; (d) comparing the at least one minimum value of first flicker level and the second flicker level; (e) adjusting a voltage of the common electrode of said LCD panel if any one of the at least one minimum value of first flicker level is not equal to the second flicker level; and (f) fixing a voltage of the common electrode of said LCD panel if each of the at least one minimum value of first flicker level is substantially equal to the second flicker level.

Other advantages and novel features of embodiments of the present invention will become more apparent from the following detailed description when taken in conjunction with the accompanying drawings.

### BRIEF DESCRIPTION OF THE DRAWINGS

FIG. 1 is an abbreviated block diagram of a liquid crystal display panel according to an exemplary embodiment of the present invention.

FIG. 2 is a flowchart of a method for adjusting voltage applied in a liquid crystal display panel, according to another exemplary embodiment of the present invention.

### DETAILED DESCRIPTION OF PREFERRED EMBODIMENTS

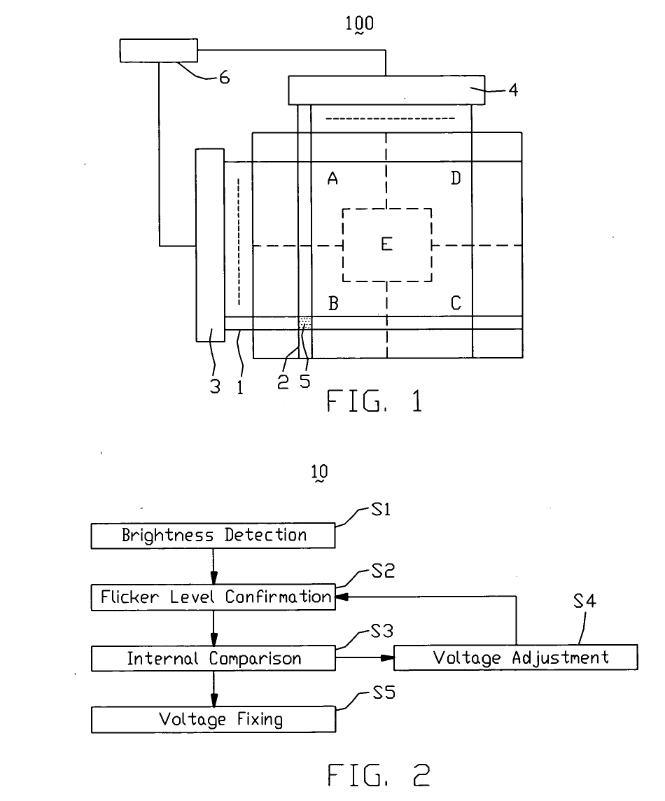

Referring to FIG. 1, this is an abbreviated block diagram of a liquid crystal display (LCD) panel according to an exemplary embodiment of the present invention. The LCD panel 100 includes a plurality of parallel scan lines 1, a plurality of parallel data lines 2, a scan driver 3, a data driver 4, a timing controller 6 connecting to both the scan driver 3 and the data driver 4, and a common electrode (not shown). The scan lines 1 and the data lines 2 cross each other and form a crisscross matrix, which defines a plurality of pixels 5. The scan driver 3 and data driver 4 are connected to the plurality of scan lines 1 and the plurality of data lines 2 respectively, so as to drive the pixels 5 to display images. In the preferred embodiment, each pixel 5 has a photo sensor (not shown) such as a photonic diode or a photonic transistor. The photo sensor can be embedded in each pixel 5 during a semiconductor manufacturing process.

In the preferred embodiment, the LCD panel 100 can be divided into five detecting areas. The first detecting area E is located in a center portion of the LCD panel 100, and other four areas (a second detecting area A, a third detecting area B, a fourth detecting area C, and a fifth detecting area D) surround the first detecting area E. The timing controller 6 is used to compare a minimum value of flicker level of each of the four detecting areas A, B, C, D to the flicker level of the first detecting area E. When one of the minimum values of flicker level (i.e. A or B or C or D) is different from the flicker level of the first detecting area E, a reference voltage of the common electrode is adjusted accordingly to eliminate the difference. If all of the minimum values of flicker level are identical to the flicker level of the first detecting area E, the reference voltage of the common electrode is fixed at its current (optimum) value. With the reference voltage fixed at the optimum value, all flicker levels over the whole LCD panel 100 should be identical.

FIG. 2 is a flowchart 10 of a method for adjusting voltage applied in an LCD panel, according to another exemplary embodiment of the present invention. In the method, flicker levels of each of pixels are measured, flicker levels from different locations on the LCD panel 100 are compared, and then an optimized common electrode voltage is calculated. The method includes the following steps:

Step S1: detecting a brightness of the first, second, third, fourth, and fifth detecting areas E, A, B, C, and D sequentially. Subsequently, the brightness data of each of the detecting areas E, A, B, C, D is transformed to a corresponding analog signal. Step S2: obtaining flicker levels e, a, b, c, and d from the corresponding first, second, third, fourth, and fifth detecting areas. Step S3: comparing variations between the flicker levels e and a, e and b, e and c, e and d by means of internal logic pre-stored in the timing controller 6 of the LCD panel 100. If each of minimum values of the flicker levels a, b, c, or d is not equal to the flicker level e, step S4 is carried out; otherwise, step S4 is skipped. Step S4: adjusting the reference voltage applied to the common electrode of the LCD panel 100 with a view to equalizing the above-described flicker levels. Then steps S1 to S3 are repeated. Steps S4 and S1 to S3 are repeated in this way as many times as needed until every minimum value of the flicker levels a, b, c, and d is equal to the flicker level e. Step S5: fixing the current reference voltage of the common electrode as the optimum value when all the minimum values of the flicker levels a, b, c, and d are equal to the flicker level e.

It is to be noted that in Step S1, the analog signals are transformed from the brightness data of the detecting areas E, A, B, C, and D. In practice, the greater an analog signal, the greater the corresponding flicker level; and vice versa. In the preferred embodiment, the 127^{th} gray level is adopted to represent a standard level of brightness of each of the five detecting areas E, A, B, C, and D among gray level gradations from 0 to 255. This is because the middle gray level is more easily recognized by the human eye.

It is to be further understood that even though numerous characteristics and advantages of various embodiments have been set forth in the foregoing description, together with details of structures and functions of certain embodiments, the disclosure is illustrative only, and changes may be made in detail, including in matters of shape, size, and arrangement of parts within the principles of the invention to the full extent indicated by the broad general meaning of the terms in which the appended claims are expressed.

We claim:

1. A liquid crystal display (LCD) panel, comprising:
a plurality of scan lines;
a plurality of data lines, said scan lines and said data lines being arranged in a matrix thereby defining a plurality of pixels;
a scan driver driving said scan lines;
a data driver driving said data lines, said data driver and said scan driver being used to drive said pixels;
a controller connected to said scan driver and said data driver; and
a common electrode;
wherein said LCD panel defines at least one first detecting area and a second detecting area, the second detecting area is located in a center portion of said LCD panel and the at least one detecting area is located in a portion of said LCD panel other than the center portion, each of the at least one first detecting area and the second detecting area comprises a photo sensor; and
when a voltage is applied to said common electrode through said controller, said photo sensors detect at least one minimum value of flicker level of the at least one first detecting area and a flicker level of the second detecting area, and said controller is configured to compare the at least one minimum value of flicker level of the at least one first detecting area with the flicker level of the second detecting area and adjust the voltage applied to said common electrode in order that the at least one minimum value of flicker level of the at least one first detecting area becomes substantially equal to the flicker level of the second detecting area.

2. The liquid crystal display panel as claimed in claim 1, wherein said photo sensor is a photonic diode.

3. The liquid crystal display panel as claimed in claim 1, wherein said photo sensor is a photonic transistor.

4. The liquid crystal display panel as claimed in claim 1, wherein said controller is further configured to fix the voltage applied to said common electrode when the at least one minimum value of flicker level of the at least one first detecting area is substantially equal to the flicker level of the second detecting area.

5. A method for adjusting voltage applied in a liquid crystal display panel (LCD), said LCD panel comprising a common electrode, at least one first detecting area, and a second detecting area, wherein the second detecting area is located in a center portion of said LCD panel and the at least one first detecting area is located in a portion of said LCD panel other than the center portion, the method comprising:
(a) detecting a brightness of the at least one first detecting area and a brightness of the second detecting area;
(b) transforming each of the brightnesses of the at least one first detecting area and the second detecting area to an analog signal;
(c) obtaining at least one minimum value of first flicker level from the at least one first detecting area and a second flicker level from the second detecting area;
(d) comparing the at least one minimum value of first flicker level and the second flicker level;
(e) adjusting a voltage of the common electrode of said LCD panel if any one of the at least one minimum value of first flicker level is not equal to the second flicker level; and
(f) fixing a voltage of the common electrode of said LCD panel if each of the at least one minimum value of first flicker level is substantially equal to the second flicker level.

6. The method as claimed in claim 5, wherein said LCD panel employs gray level gradations, and the brightnesses detected are with reference to a standard level of brightness that is a medium-range gray level in the gray level gradations.

7. The method as claimed in claim 6, wherein the medium-range gray level in the gray level gradations is a 127^{th} gray level among gray level gradations from 0 to 255.

8. The method as claimed in claim 5, wherein the brightnesses of said LCD panel are detected by at least one photonic diode.

9. The method as claimed in claim 5, wherein the brightnesses of said LCD panel are detected by at least one photonic transistor.

10. A liquid crystal display (LCD) panel, comprising:
a plurality of scan lines;
a plurality of data lines, said scan lines and said data lines being arranged in a matrix thereby defining a plurality of pixels;
a scan driver driving said scan lines;
a data driver driving said data lines, said data driver and said scan driver being used to drive said pixels;
a controller connected to said scan driver and said data driver; and
a common electrode;
wherein said LCD panel defines at least one first detecting area and a second detecting area, said second detecting area defining a smaller distance to a center of the LCD panel than the first detecting area, each of the at least one first detecting area and the second detecting area comprises a photo sensor; and
when a voltage is applied to said common electrode through said controller, said photo sensors detect at least one minimum value of flicker level of the at least one first detecting area and a flicker level of the second detecting area, and said controller is configured to compare the at least one minimum value of flicker level of the at least one first detecting area with the flicker level of the second detecting area and adjust the voltage applied to said common electrode in order that the at least one minimum value of flicker level of the at least one first detecting area becomes substantially equal to the flicker level of the second detecting area.
